(19) United States
(12) Patent Application Publication
(10) Pub. No.: US 2009/0051164 A1
(43) Pub. Date: Feb. 26, 2009

(54) Connection Element for Connecting to a Tubular Piece

(76) Inventors: Dominik Lirsch, Bruckneudorf (AT); Robert Kolbl, Tulln (AT)

Correspondence Address: NIXON & VANDERHYE, PC, 901 NORTH GLEBE ROAD, 11TH FLOOR, ARLINGTON, VA, 22203, US

(21) Appl. No.: 12/086,425

(22) PCT Filed: Dec. 18, 2006
(86) PCT No.: PCT/AT2006/000523

§ 371 Date: Jun. 12, 2008

(30) Foreign Application Priority Data
Dec. 16, 2005 (AT) A 2019/2005

(51) Int. Cl. F16L 37/098

(52) U.S. Cl. 285/321

(57) ABSTRACT

In a connection element for connecting media lines, for instance hoses (9,10) to a tube piece, in particular a tube, at least a first plug-shaped connection member (3) having at least two hose connections (1,2) is provided, whose plug part includes axially offset, radial openings (6,7) each connected with a hose connection (1,2). At least one socket-shaped connection member (26) is provided for receiving the plug-shaped connection member (3) in a manner rotational about the plug-in axis (8), the wall of which socket-shaped connection member likewise includes radial openings (14,15) at axial distances corresponding with the axial distances of the radial openings (6,7) of the plug-shaped connection member (3), wherein between adjacent radial openings (6,7,14,15) as well as to the axial end of the socket-shaped and/or plug-shaped connection member (3,26) the wall of the socket-shaped and the plug-shaped connection members (3, 26) is provided with annular or disc-shaped seals (18) sealing relative to each other.

The invention relates to a connection element for connecting media lines, for instance hoses to a tube piece, wherein at least a first plug-shaped connection member having at least two hose connections is provided, whose plug part includes axially offset, radial openings each connected with a hose connection, and wherein at least one socket-shaped connection member is provided for receiving the plug-shaped connection member in a manner rotational about the plug-in axis, the wall of which socket-shaped connection member likewise includes radial openings at axial distances corresponding with the axial distances of the radial openings of the plug-shaped connection member, wherein the walls of the socket-shaped and the plug-shaped connection members include annular or disc-shaped seals sealing relative to each other between adjacent radial openings as well as to the axial end of the socket-shaped and/or plug-shaped connection member.

A connection element of this type can, for instance, be taken from GB 2190969 A.

Connection elements for respiratory hoses or the like are, for instance, are described in DE 29823090 U1. Such a known, substantially Y-shaped connection element opens into a further tube piece, wherein a non-skid surface of the connection element was proposed to facilitate the slipping on and off of hoses.

As a rule, a considerable number of hoses are to be connected in modern respiratory devices, the individual hoses each serving different functions and, therefore, having to separately open in the interior of a tube. A rapid and proper connection of such a tube with a plurality of different hoses is, therefore, of paramount importance in connection with patient safety. Hose plug connections are basically known in various configurations. A hose plug connection including a plug part and a socket part internally formed in a manner substantially profile-complementary with the plug part is, for instance, known from DE 3529052 A1. Such a configuration will only permit mutual connection in a very particular, defined rotational position and is less suitable for use in a respiratory device, since the hose connection will have to take up different torques as a function of a patient's movement and position, which will subsequently also exert respective torques on the tube, thus introducing undesired loads.

The invention aims to further develop a connection element of the initially defined kind to the extent that it can be rapidly connected with the respective counter connections of, for instance, a tracheal tube without involving risk of confusion and, after the safe connection, will allow for an appropriate freedom of movement without affecting the tight and safe connection of a plurality of different hoses with the respective plurality of openings correspondingly provided in the tube and opening at different distances. Thus, both the sealing effect and the correct assignment of the individual hoses to the respective openings in the interior of a tube are to be maintained in any position, and a particularly simple connection of a plurality of different hoses for different gases or different measuring procedures is to be safeguarded while avoiding any risk of confusion. To solve this object, the connection element according to the invention, departing from a configuration in which at least a first plug-shaped connection member having at least two hose connections is provided, whose plug part includes axially offset, radial openings each connected with a hose connection, wherein at least one socket-shaped connection member is provided for receiving the plug-shaped connection member in a manner rotational about the plug-in axis, the wall of which socket-shaped connection member likewise includes radial openings at axial distances corresponding with the axial distances of the radial openings of the plug-shaped connection member, wherein the walls of the socket-shaped and the plug-shaped connection members include annular or disc-shaped seals sealing relative to each other between adjacent radial openings as well as to the axial end of the socket-shaped and/or plug-shaped connection member, essentially consists in that the plug-in depth of the plug-shaped connection member is limited by resilient stops and the resilient stops are designed as resilient locking members latching with counter stops. By the plug parts according to the invention being rotationally received in socket-shaped connection members and the respective, at least two hose connections of each plug part opening at different axial distances from each other via radial openings, it has become feasible to ensure the correct entry of the respective, radially emerging gas or radially withdrawn gas into a respective annular groove or a respective socket-side opening, even at a rotation of the plug-shaped connection member. The structurally particularly simple configuration of plug parts and socket-shaped connection members allows a plug part and a corresponding socket-shaped connection member to be each designed for two or even more hose connections, wherein, in the case of a larger number of hose connections and, in particular, for four or more hose connections, plug parts having a first diameter corresponding with the outer diameter will be selected for two such hose connections and, for the respective further plug parts, outer diameters differing from those of the first plug parts will be selected so as to enable the safe assignment of the respective connections via a simple plug-in connection. To this end, the configuration is preferably devised such that, for a number of hose connections exceeding the number of hose connections fixable to a first plug-shaped, or the respective socket-shaped, connection member, further plug-shaped and socket-shaped connection members having outer and inner diameters respectively differing from those of the first connection members are provided. It is, thus, feasible to select hose connections serving to measure the pressure and/or gas composition, including plug parts having larger or smaller diameters than the diameter of the plug part for the supply of gases, and optionally gases to be introduced with different pulse frequencies at different locations either simultaneously or consecutively.

When inserting the plug part into the socket-shaped connection member, it must basically be ensured that the respective, radially opening connections are in mutual alignment in the axial direction or can be mounted in a gas-tight connection. To this end, the configuration is devised such that the plug-in depth of the plug-shaped connection member is limited by resilient stops, which resilient stops are, at the same time, designed as resilient locking members latching with resilient counter-stops. Such resilient stops will thus, on the one hand, ensure the correct plug-in position and, on the other hand, at the same time provide securement against extraction at the simultaneous maintenance of the turnability of the plug part within the sleeve.

The connection element in a constructionally particularly simple manner can be configured such that the radial openings are formed by annular grooves or open into annular grooves, wherein O-ring seals are preferably arranged between adjacent annular grooves and outside the same.

In a particularly simple manner, the configuration according to the invention is devised such that connection boxes carrying the socket-shaped connection members are provided for the supply of gas. Such a configuration enables the hoses to be removed between the gas supply line, or the respective measuring device, and the tube so as to substantially facilitate required cleaning.

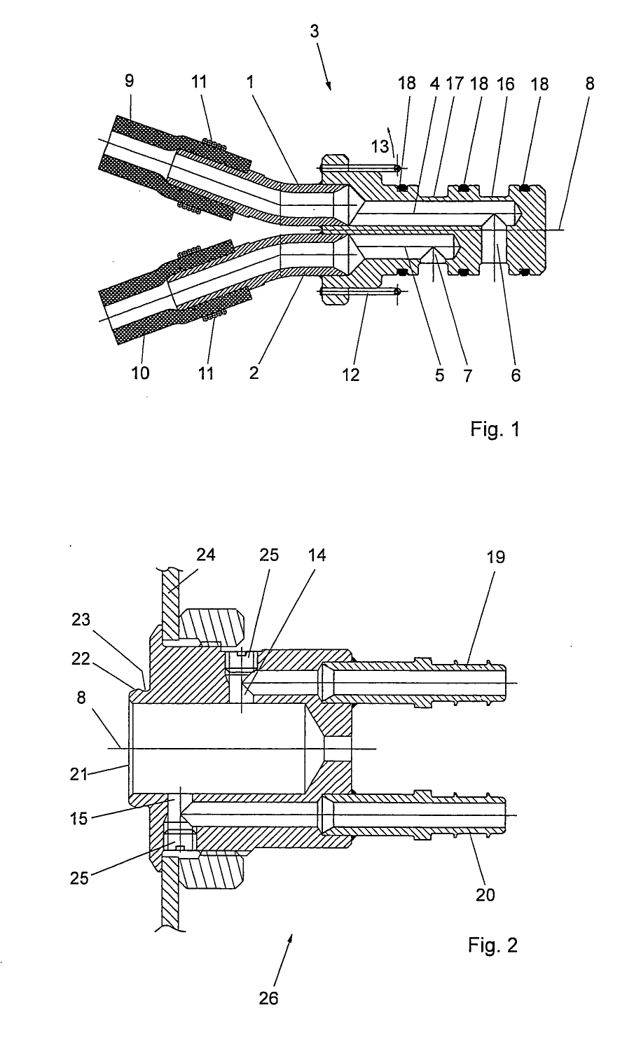

In the following, the invention will be explained in more detail by way of an exemplary embodiment schematically illustrated in the drawing. Therein, FIG. 1 depicts a cross section through a plug part with two slipped-on hose ends; and FIG. 2 depicts a cross section through a respective socket-shaped connection member for use along with a plug according to FIG. 1.

From FIG. 1, two hose connections 1 and 2 are apparent, which are connected to a plug part 3 and open into axially adjacent radial openings 6 and 7 via substantially axial channels 4 and 5, respectively. The axis is schematically indicated by a chaindotted line 8. The plug part carries two hoses 9 and 10, which can be used for different purposes. Such hoses, in particular, can be provided in respiratory devices for the supply of respiratory gases, whereby oxygen is suppliable in a pulsating or modulated manner in modern respiratory devices. The gas each pulsating at appropriate frequencies is to subsequently enter the interior of a tube at different locations such that separate radial openings 6 and 7 leading to such different positions in the interior of the tube are of substantial importance in order to enable the functioning of the device.

In FIG. 1, clamping spirals intended to ensure the safe seat of the hoses are denoted by 11. Resilient stops comprised of spring clips connected with the plug-shaped connection member so as to be outwardly pivotable in the sense of double arrow 13 are denoted by 12.

FIG. 2 depicts the respective socket-shaped connection member, the radial connections each in alignment with the radial openings 6 and 7 being respectively denoted by 14 and 15. In order to ensure the safe and tight connection in different rotational positions of the plug part according to FIG. 1, annular grooves 16 and 17 are provided, which are formed on the plug-part in the configuration according to FIGS. 1 and 2. Between adjacent annular grooves 16 and 17, and outside the same, O-rings 18 are now provided as sealing elements so as to ensure an accordingly safe and gas-tight connection to the radial openings 14 and 15 in FIG. 2 after the insertion of the plug-shaped connection member according to FIG. 1 into the socket according to FIG. 2, even in a different rotational position. These radial openings subsequently pass over into axial connection members 19 and 20, which may end in the interior of a tube, for instance at different distal and/or proximal distances. An annular rib 22 is provided adjacent the plug-in end 21 of the socket-shaped connection member, which annular rib, upon insertion of the plug-shaped connection member 3, is overlapped by the resilient clips which, after a short evasion in the sense of double arrow 13 in FIG. 1, will subsequently latch into the consecutive groove 23, thus being able to counteract an extraction of the plug part from the socket. A device front plate against which the socket 26 can be screwed is denoted by 24.

In FIG. 2, the plug-in axis is again denoted by 8, the radial bores 14 and 15 being outwardly sealed by screws 25.

1. A connection element for connecting media lines, for instance hoses to a tube piece, in particular a tube, wherein at least a first plug-shaped connection member (3) having at least two hose connections (1,2) is provided, whose plug part includes axially offset, radial openings (6,7) each connected with a hose connection (1,2), and wherein at least one socket-shaped connection member (26) is provided for receiving the plug-shaped connection member (3) in a manner rotational about the plug-in axis (8), the wall of which socket-shaped connection member likewise includes radial openings (14,15) at axial distances corresponding with the axial distances of the radial openings (6,7) of the plug-shaped connection member (3), wherein the walls of the socket-shaped and the plug-shaped connection members (3, 26) include annular or disc-shaped seals (18) sealing relative to each other between adjacent radial openings (6,7,14,15) as well as to the axial end of the socket-shaped (26) and/or plug-shaped connection member (3), characterized in that the plug-in depth of the plug-shaped connection member (3) is limited by resilient stops (12) and the resilient stops (12) are designed as resilient: Locking members latching with counter stops (22,23)

2. A connection element according to claim 1, characterized in that the radial openings (6,7,14,15) are comprised of annular grooves or open into annular grooves (16, 17).

3. A connection element according to claim 1, characterized in that 0-rings seals (18) are arranged between adjacent annular grooves (16, 17) and outside the same.

4. A connection element according to claim 1, characterized in that connection boxes carrying the socket-shaped connection members (26) are provided for the supply of gas.

5. A connection element according to claim 1, characterized in that, for a number of hose connections (1,2) exceeding the number of hose connections fixable to a first plug-shaped, or the respective socket-shaped, connection member (3,26), further plug-shaped and socket-shaped connection members (3,26) having outer and inner diameters respectively differing from those of the first connection members are provided.
